(19) United States
(12) Patent Application Publication
(10) Pub. No.: US 2008/0288818 A1
(43) Pub. Date: Nov. 20, 2008

(54) Method and System for Protecting Information between a Master Terminal and a Slave Terminal

(76) Inventors: Wen-Yueh Lai, Taipei (TW); Chia-Hsin Chen, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/030,209

(22) Filed: Feb. 13, 2008

(30) Foreign Application Priority Data
May 18, 2007 (TW) 096117842

(51) Int. Cl. G06F 11/07

(52) U.S. Cl. 714/15; 714/E11.021

(57) ABSTRACT

In an application system of a liquid crystal display, for protecting transmissions between a master terminal and a slave terminal, effects caused by an unstable power source of the slave terminal have to be reduced to a lowest degree. When the application system is reset or under normal operations with the power source having a suddenly-decreased or suddenly-unstable voltage level, the transmission between the master terminal and the slave terminal have to be terminated, and related data of the terminated transmission is temporarily stored. When the voltage of the slave terminal is confirmed to reach to a stable voltage over a predetermined duration, the transmission may be restored by the stored data.

### BACKGROUND OF THE INVENTION

1. Field of the Invention

The present invention relates to a method and a system for protecting information, and more particularly, to a method and a system having a master terminal and a slave terminal for protecting information between the master terminal and the slave terminal.

2. Description of the Prior Art

In an application system of a conventional liquid crystal display, an electrically erasable programmable read-only memory (EEPROM) is further added to a master terminal as a slave terminal for storing related information of the application system. The stored related information includes data, such as a clock parameter, a brightness, a contrast, a specification of images, or an operating procedure, of the liquid crystal display. In considerations of cost for display system, the added EEPROM may also be implemented with a serial electrically erasable programmable read-only memory (Serial EEPROM).

Please refer to FIG. 1, which is a diagram of an application system 100 applied on a liquid crystal display in the prior art. As shown in FIG. 1, the application system 100 includes a master terminal 102, a slave terminal 104, and two resistors 106 and 108, where both the resistors 106 and 108 may indicate equivalent resistances of the slave terminal 104. The application system 100 is utilized for supporting the liquid crystal display 100, and is biased with a power source VDD. In other words, both the master terminal 102 and the slave terminal 104 are biased with the power source VDD. Both pins SDA and SCL shown in FIG. 1 are utilized for exchanging related data, such as clocks, between the master terminal 102 and the slave terminal 104. Moreover, a two-wire transmission interface may also be utilized for exchanging information between the master terminal 102 and the slave terminal 104. For storing data related to the application system 100 in a real-time manner, the EEPROM for implementing the slave terminal 104 may be set to a writable mode, and disables its write protection. However, when the voltage level of the power source VDD is unstable or overly low, signals transmitted between the master terminal 102 and the slave terminal are unstable as well so that the slave terminal 104 erroneously reads or stores data. In other words, transmitted information between the master terminal 102 and the slave terminal are damaged by the unstable power source VDD, and therefore, the application 100 may erroneously operate the liquid crystal display 110. The unstable or overly low power source VDD may be resulting from rapid and repeated resets of the application system 100 or insufficient power of the power source VDD.

### SUMMARY OF THE INVENTION

The claimed invention discloses an information protecting method applied on a master terminal and a slave terminal in a system. The disclosed method comprises (a)

detecting if a voltage level of a power of the slave terminal is lower than a voltage level of a reference voltage; and (b) if the voltage level of the power of the slave terminal is lower than the reference voltage, storing a data related to a transmission between the master terminal and the slave terminal, and terminating the transmission.

The claimed invention discloses a system for protecting information between a master terminal and a slave terminal. The system comprises a slave terminal, a master terminal, and a detecting device. The slave terminal has a power terminal coupled to a power. The master terminal is utilized for accessing information of the slave terminal. The detecting device is utilized for detecting the voltage level at the power terminal of the slave terminal, and for performing a detecting/protecting mechanism. The master terminal terminates or restores transmission between the master terminal and the slave terminal according to results of the detecting/protecting mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an application system applied on a liquid crystal display in the prior art.

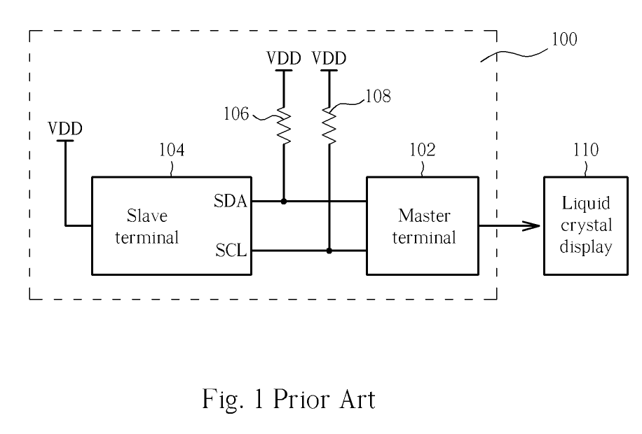

FIG. 2 is a diagram of an application system for protecting the transmission between the master terminal and the slave terminal according to a preferred embodiment of the present invention.

FIG. 3 is a flowchart of the method for protecting the transmission between the master terminal and the slave terminal, where the method is applied on the application system shown in FIG. 2.

FIG. 4 is a diagram for illustrating the transmission between the master terminal and the slave terminal when the voltage level at the power terminal of the slave terminal drops suddenly.

FIG. 5 is a state diagram for illustrating pulses of the data line and the clock line according to the detecting/protecting mechanism of the present invention while a two-wired transmission interface is applied on the transmission interface between the master terminal and the slave terminal shown in FIG. 2 and when the voltage level of the power source is unstable.

FIG. 6 illustrates the form of related data while the master terminal holds the state STATE_19 in FIG. 5 according to the detecting/protecting mechanism of the present invention.

### DETAILED DESCRIPTION

For preventing information transmitted between the master terminal and the slave terminal from being damaged by an unstable or overly low power source in the application system, a method and a system for protecting information transmitted between the master terminal and the slave terminal are disclosed in the present invention. According to embodiments of the present invention, a detecting/protecting mechanism, in which if transmission between the master terminal and the slave terminal is terminated or restored is determined according to a status of the power source of the slave terminal, is implemented so that the transmission between the master terminal and the slave terminal is prevented from being damaged by the unstable or overly low power source of the slave terminal.

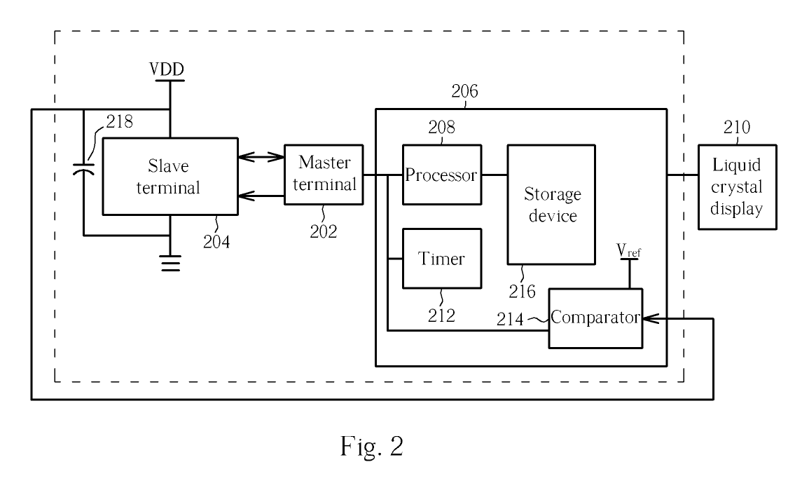

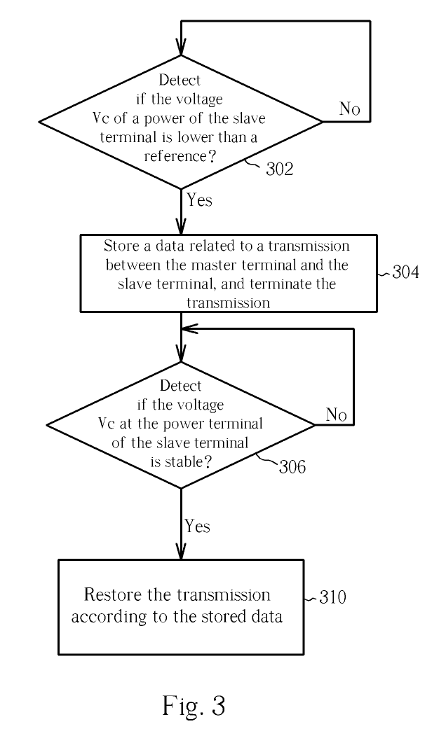

Please refer to FIG. 2 and FIG. 3. FIG. 2 is a diagram of an application system 200 for protecting the transmission between the master terminal 202 and the slave terminal 204 according to a preferred embodiment of the present invention. FIG. 3 is a flowchart of the method for protecting the transmission between the master terminal 202 and the slave terminal 204, where the method is applied on the application system 200 shown in FIG. 2.

As shown in FIG. 2, the application system 200 includes a master terminal 202, a slave terminal 204, and a detecting device 206, and is coupled to a liquid crystal display 210 for supporting the liquid crystal display 210. The transmission between the master terminal 202 and the slave terminal 204 in the present invention is implemented in a similar manner with the transmission between the master terminal 102 and the slave terminal 104 in the prior art, where the implementation is based on a two-wire transmission interface also, and thus is not described further. The master terminal 202 may access information of the slave terminal 204. Information transmitted between the master terminal 102 and the slave terminal 204 includes a shared clock and an operating procedure of both the master terminal 202 and the slave terminal 204, and parameters including a brightness, a contrast, and an image specification for supporting the liquid crystal display 210. The detecting device 206 includes a processor 208, a timer 212, a comparator 214, and a storage device 216. The detecting device 206 is utilized for detecting the voltage level of the power source VDD coupled to the slave terminal 204 with its elements, and for performing a detecting/protecting mechanism. The master terminal 202 terminates or restores the transmission between the master terminal 202 and the slave terminal 204 according to a result of the detecting/protecting mechanism. The comparator 214 is utilized for comparing voltage levels of the power source VDD and a reference voltage Vref, and for outputting a comparison result signal for indicating which one among the compared voltage levels is higher. The processor 208 is utilized for performing the detecting/protecting mechanism of the detecting device 206 according to the comparison result signal from the comparator 214, and for providing the result of the detecting/protecting mechanism. The timer 212 is utilized for providing its hour-counting function for the processor 208 when the detecting/protecting mechanism is performed by the detecting device 206. The storage device 216 is utilized for storing related data transmitted between the master terminal 202 and the slave terminal 204 through the processor 208 when the detecting/protecting mechanism is performed by the detecting device 206. In a preferred embodiment of the present invention, the storage device 216 is implemented with a random access memory (RAM) for storing necessary data in a real-time and dynamic manner when the transmission between the master terminal 202 and the slave terminal 204 is terminated. The slave terminal 204 is further connected with a power-storing element 218 in parallel so that the voltage level of the power source VDD coupled to a power terminal of the slave terminal 204 is decreased smoothly. In a preferred embodiment of the present invention, the power-storing element 218 is implemented with a capacitor.

The method disclosed in FIG. 3 with respect to the detecting/protecting mechanism includes steps as follows:

Step 302: Detect if the voltage level of a power of the slave terminal 204 (hereinafter, the voltage level is referred to the voltage Vc is lower than a reference voltage Vref. When the voltage Vc at the power terminal of the slave terminal 204 is lower than the reference voltage Vref, go to Step 304. Otherwise, repeat Step 302.

Step 304: If the voltage Vc at the power terminal of the slave terminal 204 is lower than the reference voltage Vref, store a data related to a transmission between the master terminal 202 and the slave terminal 204, and terminate the transmission.

Step 306: Detect if the voltage Vc at the power terminal of the slave terminal 204 is stable for a predetermined time. If the voltage Vc at the power terminal of the slave terminal 204 is stable for the predetermined time, go to Step 310. Otherwise, repeat Step 306.

Step 310: Restore the transmission between the master terminal 202 and the slave terminal 204 according to the data stored in Step 304.

In Step 302, when the detecting device 206 is normally operated, or when the application system 200 is just reset, the voltage Vc at the power terminal of the slave terminal 204 is repeatedly compared with the reference voltage Vref by the comparator 214 for detecting the voltage Vc at the power terminal of the slave terminal 204 is lower than the reference voltage Vref.

When the voltage Vc at the power terminal of the slave terminal 204 is lower than the reference voltage Vref, in Step 304, the processor 208 orders the storage device 216 to store data related to a transmission between the master terminal 202 and the slave terminal 204, and orders the master terminal 202 to terminate the transmission with the slave terminal 204 for preventing transmitted information from being damaged by the unstable or overly low power source VDD.

In Step 306, the processor 208 detects if the voltage Vc at the power terminal of the slave terminal 204 is higher than the reference voltage Vref with the aid of the comparator 214, and detects if the voltage Vc at the power terminal of the slave terminal 204 is higher than the voltage Vc of the reference voltage Vref for a predetermined time with the aid of the timer 212, where the related operations are indicated in Step 306. Under the condition that the voltage Vc at the power terminal of the slave terminal 204 is stable, the voltage Vc is not higher than the reference voltage Vref, or the voltage Vc is higher than the reference voltage Vref without exceeding the predetermined time, it is not proper to continue the transmission. It may also indicate that the power source VDD is not stable. Therefore, Step 306 has to be performed again under such circumstances.

In Step 310, when the voltage Vc at the power terminal of the slave terminal 204 is higher than the reference voltage Vref and is stable for the predetermined time, it is proper to restore the transmission under the current voltage level Vc. The processor 208 then orders the master terminal 202 to restore the transmission according to data stored in the storage device 216 corresponding to Step 204. Note that a start of the restored transmission should not be limitations to the present invention.

In this case, when the processor 208 detects the voltage Vc at the power terminal of the slave terminal 204 is lower than a minimum operation voltage Vmin and then is higher than the reference voltage Vref, and then the voltage Vc at the power terminal of the slave terminal 204 is stable for the predetermined time, the processor 208 allows the transmission, but the transmission is not sure to be restored.

Note that in a preferred embodiment of the present invention, a length of the predetermined time is 20 milliseconds, the reference voltage is 3.3 volts, the voltage Vc corresponding to a stable state of the power source VDD is 5 volts, a voltage level Vmax indicating an upper bound of the voltage level Vc is 5.5 volts, and a voltage level Vmin indicating a lower bound of the voltage level Vc is 1.8 volts.

For ensuring capturing transmitted data right before the transmission is terminated, where the transmitted data is important for initiating a next transmission between the master terminal 202 and the slave terminal 204, certain adaptation is added in Step 304. In the added adaptation of Step 304, the storage device 216 further stores end information in a last transmission between the master terminal 202 and the slave terminal 204, and then the processor 208 orders the master terminal 202 to terminate the transmission.

For ensuring soundness of transmitted data right before the transmission is terminated when said transmission is restored and initiated again, an other adaptation is added in Step 310. In the added adaptation of Step 310, the transmission is restored from the transmission right before the termination, according to stored data of the terminated transmission.

When the abovementioned adaptations are added and adopted in Step 304 and Step 310, differences of moments in storing related data corresponding to transmission terminated internal or external to one transmission merely result in tiny differences in safety of protecting transmitted data and in saving wasted transmitted time. However, since the stored data of the storage device 216 are utilized for restoring the terminated transmission, the aim of protecting the transmission is achieved.

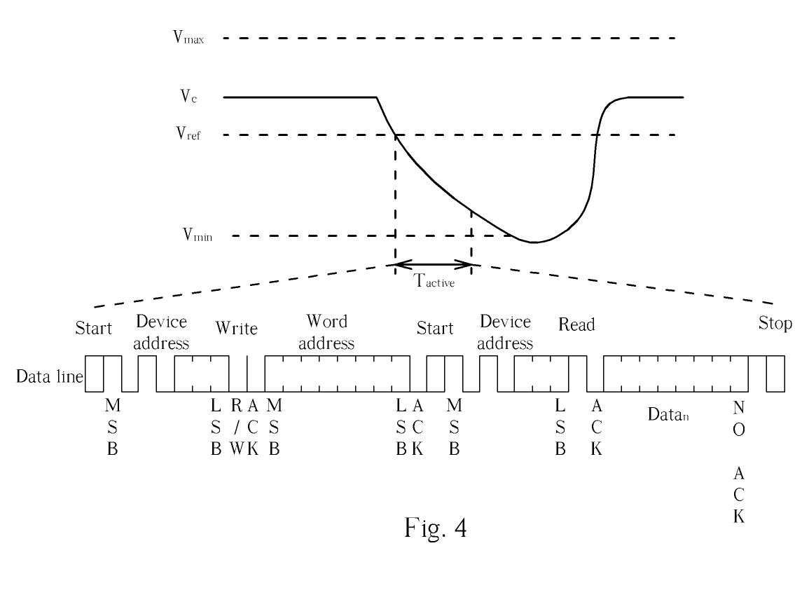

Please refer to FIG. 4, which is a diagram for illustrating the transmission between the master terminal and the slave terminal when the voltage at the power terminal of the slave terminal drops suddenly, and please refer to FIG. 2 together. For the slave terminal 204, a maximal operating voltage is Vmax, a minimum operating voltage is Vmin, and the reference voltage Vref ranges between the maximum operation voltage Vmax and the minimum operation voltage Vmin. Since the slave terminal 204 is connected with the power-storing element 218 in parallel at the power terminal of the slave terminal 204 and the ground, the voltage level at the power terminal equals a storage voltage level of the power-storing element 218, where said voltage at the power terminal is Vc.

When the voltage Vc suddenly drops, the voltage Vc is buffered with the aid of the power-storing element 218. Therefore, the voltage Vc at the slave terminal 204 drops smoothly. That is, after the detecting device 206 confirms that the voltage Vc is lower than the reference voltage Vref, and within the time T_{active} that indicates a duration before the voltage Vc at the slave terminal 204 drops below the minimum operating voltage Vmin, related data in the transmission and end information in one transmission are stored. After the end information is stored, the transmission is terminated immediately. The stored data in transmission includes addresses, read/write states, input/output data between the master terminal 202 and the slave terminal 204, an end information, and includes internal states of the master terminal 202.

In FIG. 4, the voltage Vc drops under the minimum operation voltage Vmin, and then the voltage Vc rises over the reference voltage Vref, and then the voltage Vc keeps a stable state for a time. The detecting device 206 restores the transmission according to the performed detecting/protecting mechanism of the present invention. As shown in FIG. 4, the beginning of restoring the transmission is located at the leftmost start symbol of the time T_{active}.

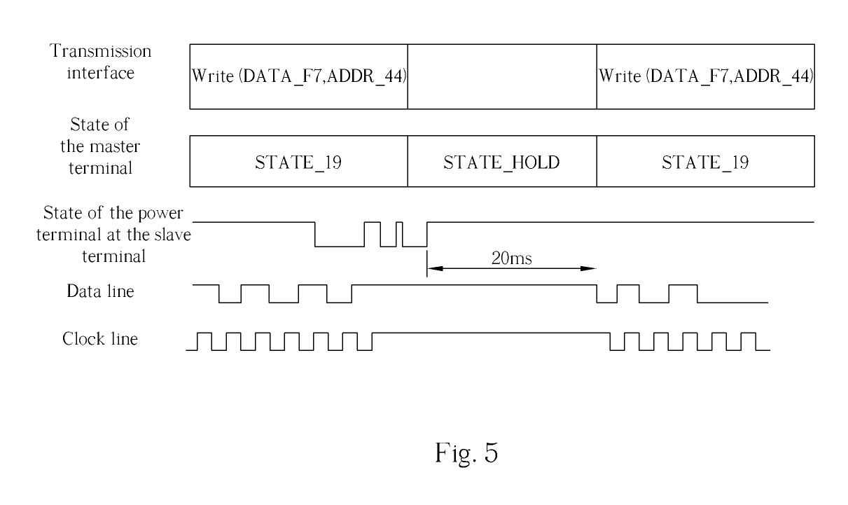

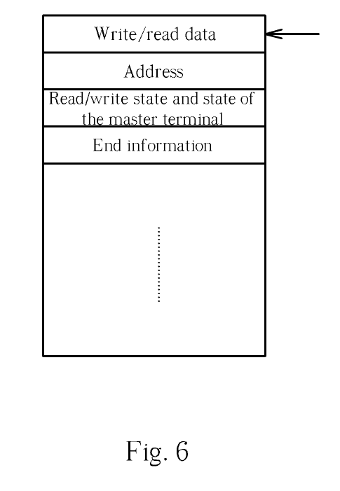

Please refer to FIG. 5, which is a state diagram for illustrating pulses of the data line and the clock line according to the detecting/protecting mechanism of the present invention while a two-wired transmission interface (such as I2C bus) is applied on the transmission interface between the master terminal 202 and the slave terminal 204 shown in FIG. 2 and when the voltage level of the power source is unstable. When the master terminal 202 holds a state STATE_19 so that the master terminal 202 writes a datum DATA_F7 at an address ADDR_44 on the slave terminal 204, which may be implemented with EEPROM, the voltage level at the power terminal is decreased suddenly. FIG. 6 illustrates the form of related data while the master terminal 202 holds the state STATE_19 in FIG. 5 according to the detecting/protecting mechanism of the present invention. As shown in FIG. 6, the related data is stored in form of stack into the storage device 216, which may be implemented with random access memory. After the related data is stored, the transmission between the master terminal 202 and the slave terminal 204 is terminated immediately so that the pulses of both the data line and the clock line stay fixed at this time. According to the detecting/protecting mechanism of the present invention, when the voltage level at the power terminal is stable, the master terminal 202 enters a waiting state, which is denoted as STATE_HOLD in FIG. 5. When the transmission is ready to be restored, the master terminal 202 reenters the state STATE_19, and rewrites the data DATA_F7 at the address ADDR_44 on the slave terminal 204 according to the data stored in the storage device 216 and shown in FIG. 6.

Those skilled in the art will readily observe that numerous modifications and alterations of the device and method may be made while retaining the teachings of the invention.

What is claimed is:

1. An information protecting method applied on a master terminal and a slave terminal in a system, comprising:
(a) detecting if a voltage level of a power of the slave terminal is lower than a reference voltage; and
(b) if the voltage level of the power of the slave terminal is lower than the reference voltage, storing a data related to a transmission between the master terminal and the slave terminal, and terminating the transmission.

2. The method of claim 1 wherein the step (b) further comprises:
storing an end information related to the transmission between the master terminal and the slave terminal; and
terminating the transmission.

3. The method of claim 1 further comprising:
(c) detecting if the voltage level of the power of the slave terminal is higher than the reference voltage and is stable for a predetermined time; and
(d) if the voltage level of the power of the slave terminal is higher than the reference voltage and is stable for the predetermined time, restoring the transmission according to the stored data.

4. The method of claim 2 further comprising:
(e) detecting if the voltage level of the power of the slave terminal is higher than the reference voltage and is stable for a predetermined time; and
(f) if the voltage level of the power of the slave terminal is higher than the reference voltage and is stable for the predetermined time, restoring the transmission according to the stored end information.

5. The method of claim 1 further comprising:
(g) detecting if the voltage level of the power of the slave terminal is lower than a minimum operation voltage and then is higher than the reference voltage, and the voltage level of the power of the slave terminal is stable for the predetermined time; and
(h) if the voltage level of the power of the slave terminal is lower than the minimum operation voltage and then is higher than the reference voltage, and the voltage level of the power of the slave terminal is stable for the predetermined time, allowing the transmission.

6. The method of claim 1 wherein the stored data comprises an address, a read/write state, a write/read data, an end information, and an internal state of the master terminal.

7. The method of claim 1 wherein the method is applied on a liquid crystal display system.

8. A system for protecting an information, comprising:
a slave terminal having a power terminal coupled to a power;
a master terminal for accessing information of the slave terminal; and
a detecting device for detecting the voltage level at the power terminal of the slave terminal, and for performing a detecting/protecting mechanism;
wherein the master terminal terminates or restores transmission between the master terminal and the slave terminal according to results of the detecting/protecting mechanism.

9. The system of claim 8 wherein the transmission between the master terminal and the slave terminal is performed with a two-wire transmission interface.

10. The system of claim 8 wherein the slave terminal is an electrically erasable programmable read-only memory (EEPROM).

11. The system of claim 8 wherein the system is applied on a liquid crystal display system.

12. The system of claim 11 wherein information transmitted between the master terminal and the slave terminal comprises a clock parameter, a brightness, a contrast, an image specification, and an operating procedure.

13. The system of claim 8 wherein the detecting device further comprises:
a comparator for comparing the voltage level at the power terminal of the slave terminal with a voltage level of a reference voltage so as to output a comparison result signal; and
a processor for performing the detecting/protecting mechanism according to the comparison result signal, and for providing results of the detecting/protecting mechanism.

14. The system of claim 8 wherein the detecting device further comprises:
a timer for providing its clocking function for the processor when the detecting/protecting mechanism is performed; and
a storage device for storing related data of the transmission between the master terminal and the slave terminal through the processor when the detecting/protecting mechanism is performed.

15. The system of claim 14 wherein when the voltage level at the power terminal of the slave terminal is lower than the reference voltage, the detecting/protecting mechanism orders the storage device to store the related data and then orders the master terminal to terminate the transmission after the transmission is completed.

16. The system of claim 14 wherein the related data comprises an address, a read/write state, a write/read data, an end information, and an internal state of the master terminal.

17. The system of claim 8 wherein the slave terminal is connected with a power-storing element in parallel for stabilizing the voltage level of the power terminal of the slave terminal.

18. The system of claim 17 wherein the power-storing element is a capacitor.
